(19) United States
(12) Patent Application Publication
(10) Pub. No.: US 2012/0071135 A1
(43) Pub. Date: Mar. 22, 2012

(54) MOBILE TERMINAL AND METHOD FOR LOCKING MESSAGE

(75) Inventor: ZU-HONG HU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/158,689

(22) Filed: Jun. 13, 2011

(30) Foreign Application Priority Data
Sep. 21, 2010 (CN) 201010288809.0

(51) Int. Cl. H04L 12/58

(52) U.S. Cl. 455/412.1

(57) ABSTRACT

A mobile terminal includes a storing module, a control module, and a locking module. The storing module is used for storing a plurality of messages. The control module is used for obtaining a message number corresponding to a message of the plurality of messages after determining the message associated with a reference condition. The locking module is used for locking the message according to the message number.

### CROSS-REFERENCE TO RELATED APPLICATIONS

Relevant subject matter is disclosed in co-pending U.S. Patent Applications entitled “MOBILE TERMINAL AND METHOD FOR DELETING MESSAGE”, Attorney Docket Number US35195, US Application No. ______, Filed on ______.

### BACKGROUND

1. Technical Field

The present disclosure relates to mobile terminals and methods, and particularly to, an mobile terminal and method for locking messages.

2. Description of Related Art

Message service is widely applied in all kinds of mobile terminals. Each mobile terminal can store hundreds of messages. Sometimes, users may delete messages to save memory of the mobile terminal. However, if users are not careful they may delete important messages.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of a mobile terminal in accordance with an embodiment.

FIG. 2 is a flow chart of a method for locking a message in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

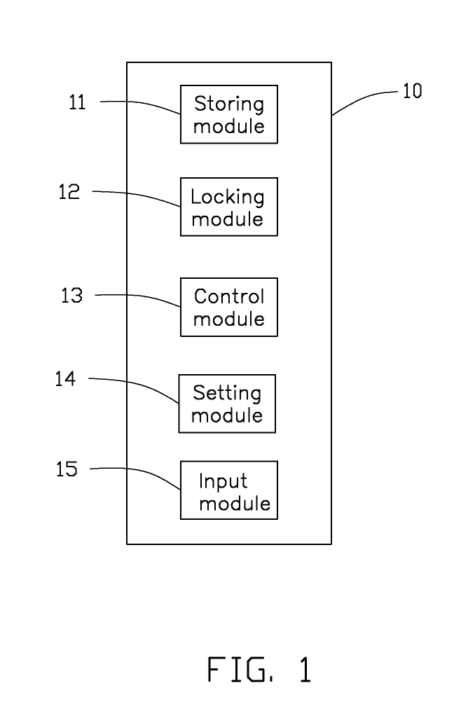

Referring to FIG. 1, a mobile terminal 10 includes a storing module 11, a locking module 12, a control module 13, a setting module 14, and an input module 15.

The storing module 11 is used for receiving and storing messages from message senders. The message senders may be, for example, contacts that have been in communication with the user. Each message includes 2 bytes for storing a message number, 10 bytes for storing the name or telephone number of the message sender, 12 bytes for storing the receiving time, 1 byte for storing a read label, 160 bytes for storing the content of the message, and N bytes for storing other data. If the name of the message sender is stored in the mobile terminal 10, the 10 bytes stores the name of the message sender; and if the name of the message sender is not stored in the mobile terminal 10, the 10 bytes stores the telephone number of the message sender. A message number corresponds to a message. For example, in the storing module 11, a message number of the first message is 1, a message number of the second message is 2. Likewise, a message number of the Nth message is N.

The control module 13 is used for obtaining a message number corresponding to a selected message associated with a name or a telephone number of a message sender. The control module 13 is further used for sending the message number to the locking module 12. The control module 13 is further used for obtaining and the name or the telephone number of the message sender and the receiving time corresponding to the message, and sending the name or the telephone number and the receiving time to the storing module to store.

The locking module 12 is used for locking the selected message according to the message number. When the selected message is locked, users cannot delete the selected message.

The setting module 14 is used for setting different reference conditions. The reference conditions includes the names or telephone numbers of message senders, receiving time of the messages, groups, such as a family group, friend group, stored in the mobile terminal 10. The input module 15 is used for receiving the names or telephone numbers input by users.

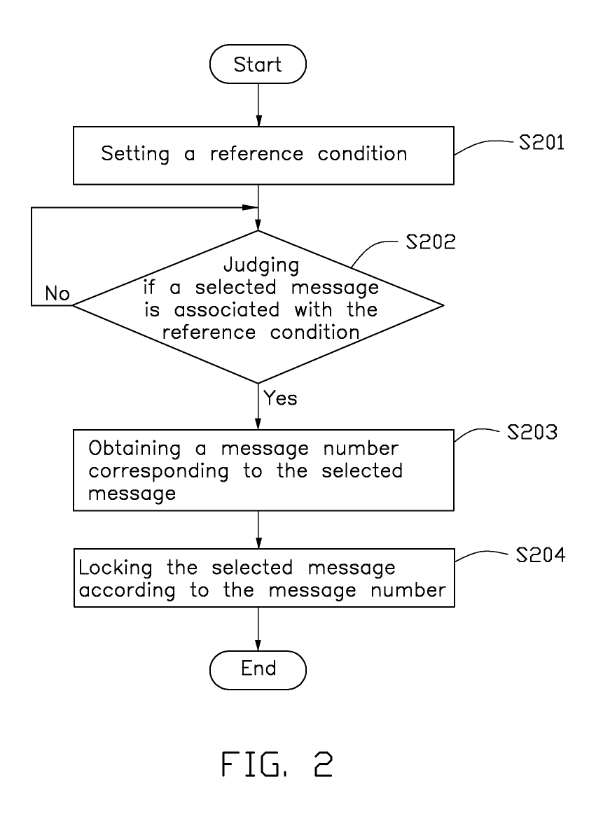

Referring to FIGS. 1 and 2, a method for locking a selected message is shown. An embodiment of the method is as follows.

In step S201, the setting module 14 sets a reference condition.

In step S202, the control module 13 judges if a selected message is associated with the reference condition. If so, the flow turns to the step S203. If not, the flow keeps the step S202.

In step S203, the control module 13 obtains a message number corresponding to the selected message and sends the message number to the locking module 12.

In step S204, the locking module 12 locks the selected message according to the message number.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A mobile terminal, comprising:
a storing module, the storing module adapted to store a plurality of messages;
a control module, the control module adapted to obtain a message number corresponding to a selected message of the plurality of messages after determining the selected message associated with a reference condition and
a locking module, the locking module adapted to lock the selected message according to the message number.

2. The mobile terminal of claim 1, wherein the reference condition is a name or a telephone number of a message sender, a receiving time or a group name corresponding to the selected message.

3. The mobile terminal of claim 1, wherein the control module is further adapted to obtain a name or a telephone number of a message sender and a receiving time corresponding to the message and send the name or the telephone number and the receiving time to the storing module when the control module obtains the message number.

4. The mobile terminal of claim 1, further comprising an input module, wherein the reference condition is a name or a telephone number of a message sender corresponding to the message, the input module is adapted to receive the name or the telephone number inputted by a user.

5. A method for locking a message, applied in a mobile terminal, the method comprising:
setting a reference condition;
obtaining a message number corresponding to a selected message stored in the mobile terminal after determining the selected message associated with the reference condition; and
locking the selected message according to the message number.

6. The method of claim 5, further comprising obtaining a name or telephone number of a message sender and a receiving time corresponding to the message; and storing the name or the telephone number and the receiving time when obtaining the message number.

7. The method of claim 5, wherein the reference condition is a name or a telephone number of a message sender, a receiving time or a group name corresponding to the message.

8. A method for locking a message, comprising:
providing a mobile terminal, the mobile terminal comprising a storing module storing a plurality of messages, a control module, a setting module, and a locking module;
the setting module setting a reference condition;
the control module obtaining a message number corresponding to a selected message of the plurality of messages after determining the selected message associated with the reference condition; and
the locking module locking the selected message according to the message number.

9. The method of claim 8, further comprising obtaining a name or a telephone number of a message sender and a receiving time corresponding to the selected message and storing the message sender name or telephone number and the receiving time when obtaining the message number.

10. The method of claim 8, wherein the reference condition is a name or a telephone number of a message sender, a receiving time or a group name corresponding to the selected message.
